(19) United States
(12) Patent Application Publication
(10) Pub. No.: US 2003/0211025 A1
(43) Pub. Date: Nov. 13, 2003

(54) Process, control system and apparatus for the optimal operation of a selective oxidation reactor

(76) Inventors: Paul G. Blommel, Blue Mounds, WI (US); Gavin P. Towler, Barrington, IL (US); Suheil F. Abdo, Lincolnshire, IL (US); Daniel R. Sioui, Arlington Heights, IL (US); Kenneth J. Stippich JR., Palatine, IL (US); John R. Harness, Elgin, IL (US); Kurt M. Vanden Bussche, Lake in the Hills, IL (US)

Correspondence Address: JOHN G TOLOMEI, PATENT DEPARTMENT, UOP LLC, 25 EAST ALGONQUIN ROAD, P O BOX 5017, DES PLAINES, IL, 60017-5017, US

(21) Appl. No.: 10/141,671

(22) Filed: May 7, 2002

(51) Int. Cl. B01D 53/62; B01J 8/00

(52) U.S. Cl. 423/247; 423/652; 422/190; 422/105; 422/211

(57) ABSTRACT

The present invention provides a process of selectively oxidizing carbon monoxide in a reformate stream comprising the steps of passing a fuel stream comprising hydrogen and carbon monoxide into a reaction chamber wherein the reaction chamber contains an effective amount of at least one catalyst to promote oxidation of said carbon monoxide to carbon dioxide; supplying an oxygen-containing stream into said reaction chamber; and periodically interrupting the flow of said oxygen-containing stream into said reaction chamber. In one embodiment of the invention, the oxygen-containing stream is interrupted for a predetermined duration of time. In general, it was found that more frequent short interruptions of the oxygen flow produced a consistently lower carbon monoxide level than less frequent longer interruptions. The interruption in oxygen flow may also be triggered upon an increase in carbon monoxide concentration within the reaction chamber.

### FIELD OF THE INVENTION

The present invention is a process which relates generally to the operation of a fuel cell and a fuel processor which converts a hydrocarbon or oxygenate into a fuel stream for use by the fuel cell. More particularly, the invention relates to a process and a control system for the operation of a preferential oxidation reactor to convert carbon monoxide to carbon dioxide.

### BACKGROUND OF THE INVENTION

Fuel cells are, in general, gas-operated electrochemical devices in which the energy obtained from the reaction of gas streams comprising hydrogen and oxygen is collected directly as electrical energy. The present invention describes the use of catalysts for preparation of the fuel gas stream for use in fuel cells, in particular for PEM (proton exchange membrane) fuel cells. This type of fuel cell is becoming increasingly important, due to its high energy density and low operating temperature, for use in the vehicle industry, i.e. for providing electro-traction in motor vehicles, or for distributed stationary generation of electrical power.

The advantages of a vehicle powered by fuel cells are the very low emissions and the high degree of efficiency of the total system compared with conventional internal combustion engines. When hydrogen is the major component in the fuel gas, the primary emission product of the conversion in the fuel cell is water. The water is produced on the cathode side of the fuel cell. The vehicle is then a so-called ZEV (zero emission vehicle). The use of hydrogen in fuel cells requires that hydrogen be available on the anode side of the fuel cell membrane to actually generate power. The source of the hydrogen can be stationary or mobile. Stationary sources of hydrogen will require a distribution and dispensing system like motor gasoline. Mobile sources for hydrogen will include on-board hydrogen generators for the conversion of hydrocarbon fuels to hydrogen. However, hydrogen presents many handling and distribution problems which will not be resolved before the fuel cell powered vehicles reach the market. The infrastructure for the widespread distribution of hydrogen is still too expensive at the moment and there are other problems with the storage and refueling of vehicles. For this reason, the alternative, producing hydrogen directly on board the vehicle by reforming hydrocarbon fuels or oxygenated fuels is growing in importance. For example, methanol can be stored in a fuel tank of the vehicle and on demand converted by a steam reforming process at 200° to 300° C. to a hydrogen-rich fuel gas with carbon dioxide and carbon monoxide as secondary constituents. After converting the carbon monoxide by a shift reaction, preferential oxidation (prefox) or another purification process, this fuel gas, or reformate gas is supplied directly to the anode side of the PEM fuel cell. Theoretically, the reformate gas consists of 75 vol-% hydrogen and 25 vol-% carbon dioxide. In practice, however, the reformate gas also will contain nitrogen, oxygen and, depending on the degree of purity, varying amounts of carbon monoxide (up to 1 vol-%).

The PEM fuel cell comprises layers of catalyst comprising platinum and platinum alloys on the anode and cathode sides of PEM fuel cells. These catalyst layers consist of fine, noble metal particles which are deposited onto a conductive support material (generally carbon black or graphite). The concentration of noble metal is between 10 and 40 wt-% and the proportion of conductive support material is thus between 60 and 90 wt-%. The crystallite size of the particles, determined by X-ray diffraction (XRD), is about 2 to 10 nm. Traditional platinum catalysts are very sensitive to poisoning by carbon monoxide; therefore the CO content of the fuel gas must be lowered to <100 ppm in order to prevent power loss in the fuel cells resulting from poisoning of the anode catalyst. Since the PEM fuel cell operates at a relatively low operating temperature of between 70° and about 100° C., the catalyst is especially sensitive to CO poisoning.

Due to the fact that carbon monoxide is formed through the steam reforming process and that carbon monoxide will poison the fuel cell anode, it is necessary for there to be at least one and more often, a series of CO removal steps to be included in a fuel processor zone. One of the most common CO removal or hydrogen purification steps is a water gas shift conversion zone.

When it is required to reduce the CO concentration to very low levels, such as less than 50 ppm mol, or less than 10 ppm mol, a preferential oxidation step may follow the water gas shift step. In the preferential oxidation step, the hydrogen fuel stream at effective conditions is contacted with a selective oxidation catalyst in the presence of an oxygen-containing stream to selectively oxidize carbon monoxide to carbon dioxide and produce a fuel stream comprising between about 10 and 50 ppm-mol carbon monoxide. In the preferential oxidation reaction, a substantially higher degree of oxidation of carbon monoxide to carbon dioxide occurs than the undesirable reaction of the hydrogen with oxygen to produce water that would reduce the output of desired hydrogen. The thus purified fuel stream is passed to an anode side of the fuel cell and an air stream is passed to the cathode side of the fuel cell. Common catalysts used to promote the selective oxidation of carbon monoxide include at least one metal selected from the group consisting of platinum, palladium, ruthenium, gold, rhodium and iridium and alloys of two or more metals from this group. The metal is supported on a support material selected from the group consisting of alumina, titania, silica, a zeolite or other support material serving the same purpose.

It has been recognized for some time that under certain process conditions, the catalyst suffers from a rapid deactivation. During the deactivation, the levels of carbon monoxide increase. This problem has been reported by others. In U.S. Pat. No. 5,750,076 B1, the performance of the selective oxidation catalyst is reported as decaying gradually due to the gradual blanketing of the catalyst active sites with carbon monoxide. Eventually, there is a rapid increase in concentration of carbon monoxide. The use of an increased temperature catalyst bed is reported as compensating for the loss of catalyst activity, but resulting in undesirable increased hydrogen consumption. The problem of increased carbon monoxide level is dealt with by a flow reversal through the catalyst bed that is said to be to regenerate the catalyst. The theory advanced in this patent is that strong adsorption of CO blocks the access of oxygen to the catalytic sites. A similar process is disclosed in U.S. Pat. No. 5,518,705 B1.

U.S. Pat. No. 6,168,772 B1 describes what are considered the optimal conditions for maintaining a reduced level of carbon monoxide including temperature, ratio of oxygen to carbon dioxide and flow direction. The purpose of these conditions was to avoid excessive combustion of the hydrogen product.

It has been found advantageous to use a single or multistage reactor to selectively oxidize carbon monoxide with oxygen to produce carbon dioxide. The use of such reactors has been found to reduce the CO level in reformate to levels acceptable for consumption in a PEM fuel cell. A problem that has been observed with both the single and the multistage reactor systems is a gradual decline in the CO removal capability.

An object of the present invention is to provide an apparatus and process for selective oxidation of CO that continues to function at reasonably high capacity. It is a further object of the present invention to employ an interruption of oxygen flow to the reactor system to achieve effluent concentrations of CO of less than 50 ppm-vol. Another objective of the present invention is to maintain efficient production of hydrogen while reducing CO levels below a level that interferes with fuel cell anode operation.

### SUMMARY OF THE INVENTION

The present invention provides a process of selectively oxidizing carbon monoxide in a reformate stream comprising the steps of passing a fuel stream comprising hydrogen and carbon monoxide into a reaction chamber wherein the reaction chamber contains an effective amount of at least one catalyst to promote oxidation of said carbon monoxide to carbon dioxide; supplying an oxygen-containing stream into said reaction chamber; and periodically interrupting the flow of said oxygen-containing stream into said reaction chamber. One or a combination of methods may be employed to trigger the oxygen interruption. In one embodiment of the invention, the oxygen-containing stream is interrupted for a predetermined duration of time. In general, it was found that more frequent short interruptions of the oxygen flow produced a consistently lower carbon monoxide level than less frequent longer interruptions. In operation of the fuel processor, one skilled in the art can determine the optimal interval between interruption of oxygen flow as well as the period during which the oxygen flow is interrupted. The interruption in oxygen flow may also be triggered upon an increase in carbon monoxide concentration within the reaction chamber.

One embodiment of the present invention is a process of selectively oxidizing carbon monoxide in a reformate stream comprising the steps of first passing a fuel stream comprising hydrogen and carbon monoxide into a reaction chamber, wherein the reaction chamber contains an effective amount of at least one catalyst to selectively promote oxidation of carbon monoxide to carbon dioxide in the presence of hydrogen; supplying an oxygen-containing stream into the reaction chamber and periodically interrupting the flow of the oxygen-containing stream into the reaction chamber.

Another embodiment of the invention comprises an apparatus for selectively oxidizing carbon monoxide to carbon dioxide in a fuel stream comprising hydrogen and carbon monoxide, the apparatus comprising a primary reaction chamber comprising a primary catalyst bed for promoting oxidation of carbon monoxide to carbon dioxide, the primary reaction chamber further comprising at least one inlet for directing said fuel stream through the primary catalyst bed and at least one inlet for directing an oxygen-containing stream through the primary catalyst stream; a flow controller for periodically interrupting the oxygen-containing stream flowing into said primary reaction chamber; and at least one outlet from said primary reaction chamber.

The present invention is also a process for the generation of a hydrogen-rich fuel gas stream for use in a fuel cell for the generation of electric power, the process comprising passing a feed stream comprising a hydrocarbon or an oxygenate to a fuel processor comprising an integrated reforming and water gas shift conversion zone to produce a fuel stream comprising hydrogen, carbon monoxide, carbon dioxide, nitrogen and water passing the fuel stream at an oxidation temperature between 70° C. and less than 160° C. in the presence of an oxygen-containing stream to a preferential oxidation zone containing a preferential oxidation catalyst to produce the hydrogen-rich fuel gas stream comprising less than about 50 ppm-vol carbon monoxide, said preferential oxidation catalyst consisting of ruthenium metal dispersed on an alumina carrier having an apparent bulk density of about 0.2 to about 0.4 g/cc and wherein at least a portion of said alumina carrier has an average pore size of about 800 to about 1500 angstroms; periodically, interrupting said oxygen-containing stream for a period of time sufficient to maintain said carbon monoxide below a desired level; and passing the hydrogen-rich fuel gas stream to a fuel cell for the generation of electric power and withdrawing electric power.

### BRIEF DESCRIPTION OF THE DRAWINGS

FIG. 1 is a schematic block diagram illustrating the present invention having a single reaction chamber.

FIG. 2 is a schematic block diagram illustrating the embodiment of the present invention having a primary reaction chamber and a secondary reaction chamber.

FIG. 3 shows an example of the gradual increase in fuel processor product carbon monoxide that results from not using the oxygen flow interruption of the present invention.

FIG. 4 is a chart illustrating the effectiveness of the flow interruption method of the present invention.

FIG. 5 is a chart illustrating the effectiveness of an air pulse of ten seconds duration that is administered after about 52 hours of operation.

### DETAILED DESCRIPTION OF THE INVENTION

In the process of producing electricity from an integrated fuel processor and fuel cell, a hydrocarbon or oxygenate feedstock is processed to produce hydrogen and the hydrogen is passed to the fuel cell to produce the electric power. In some such processes, air, also referred to as an oxygen-containing stream herein, is employed at various points in the integrated fuel processor and fuel cell as a reactant in the catalytic zones of the fuel processor and on the cathode side of the fuel cell. In the fuel processor, air is combined with anode waste gas or a fuel stream and burned in a burner zone to recover or provide heat to reforming zones which undergo endothermic reactions in the presence of steam to convert at least a portion of the feedstock to hydrogen and carbon monoxide. Accordingly, the burner temperature or the temperature of the effluent gases from the burner zone is controlled by adjusting the flow of air to the burner. The burner effluent gases, or exhaust gases, are used to provide heat to reforming zones, generate steam or combinations thereof.

One method of reforming gaseous or liquid hydrocarbon fuels is by catalytic steam reforming. In this process a mixture of steam and the hydrocarbon fuel is exposed to a suitable catalyst at a high temperature. The catalyst used is typically nickel and the temperature is usually between about 700° C. and about 1000° C. In the case of methane, hydrogen is liberated in a catalytic steam reforming process according to the following simplified overall reaction:

CH₄+H₂O→CO+3H₂ (1)

This reaction is highly endothermic and requires an external source of heat and a source for steam. Commercial steam reformers typically comprise externally heated, catalyst filled tubes and rarely have thermal efficiencies greater than about 60%.

Another conventional method of reforming a gaseous or liquid hydrocarbon fuel is partial oxidation reforming. In these processes, a mixture of the hydrocarbon fuel and an oxygen-containing gas are brought together within a partial oxidation chamber and subjected to high temperatures—though lower for a catalyzed reaction.

An additional known method of reforming a hydrocarbon fuel is by autothermal reforming (ATR). An autothermal reformer uses a combination of steam reforming and partial oxidation reforming. Waste heat from the partial oxidation reforming reaction is used to heat the thermally steam reforming reaction. An autothermal reformer may in many cases be more efficient than either a catalytic steam reformer or a catalytic partial oxidation reformer. Again, in using methane, or natural gas, as the hydrocarbon fuel, hydrogen is liberated according to the following simplified overall reaction:

CH₄+H₂O+O₂→CO₂+H₂ (2)

In addition to the reforming reactions discussed above it is usually necessary to consider the effects of another reaction occurring, the so-called “water gas shift reaction.” Because the equilibrium of this reversible reaction is temperature (T) dependent, and at high temperatures carbon monoxide and water tend to be produced, the effects warrant consideration In the water gas shift reaction the following overall reaction occurs:

CO+H₂O←→CO₂+H₂ (3)

More favorable results, however, is that given equilibrium conversion at low temperatures carbon dioxide and hydrogen tend to be produced. Typical reformers produce carbon dioxide and hydrogen, and consequently some carbon dioxide and hydrogen react to produce concentrations of carbon monoxide and water due to the reverse water gas shift reaction occurring in the reforming chamber. As mentioned previously, this is undesirable because the concentration of carbon monoxide must be either completely removed or at least reduced to a low concentration—i.e., less than about 100 ppm after the shift reaction—to avoid poisoning the anode of the PEM-FC. Carbon monoxide concentrations of more than 20 ppm reaching the PEM-FC can quickly poison the catalyst of the fuel cell's anode. In a shift reactor, water (i.e., steam) is added to the hydrocarbon reformate/effluent exiting the reformer, in the presence of a suitable catalyst, to lower its temperature, and increase the steam to carbon ratio therein. The higher steam to carbon ratio serves to lower the carbon monoxide content of the reformate to less than 100 ppm according to the shift reaction (4) above. Ideally, the carbon monoxide concentration can be maintained below 1 ppm with the right shift catalyst, but the temperature required for this, about 100° C. to 125° C. is too low for operation of current shift catalysts.

Advantageously, it is possible to recover some hydrogen at the same time by passing the product gases leaving the reforming vessel, after cooling, into a shift reactor where a suitable catalyst promotes the carbon monoxide and water/steam to react to produce carbon dioxide and hydrogen. The shift reactor provides a convenient method of reducing the carbon monoxide concentration of the reformer product gases, while simultaneously improving the yield of hydrogen. However, some carbon monoxide still survives the shift reaction. Depending upon such factors as reformate flow rate and steam injection rate, the carbon monoxide content of the gas exiting the shift reactor can be as low as 0.5 mol percent.

The shift reaction is typically not enough to sufficiently reduce the carbon monoxide content of the reformate (i.e., below about 100 ppm). Therefore, it is necessary to further remove carbon monoxide from the hydrogen-rich reformate stream exiting the shift reactor, prior to supplying it to the fuel cell. It is known to further reduce the carbon monoxide content of hydrogen-rich reformate exiting a shift reactor by a so-called preferential oxidation (“Prefox”) reaction (also known as “selective oxidation”) effected in a suitable Prefox reactor. A Prefox reactor usually comprises a catalyst bed which promotes the preferential oxidation of carbon monoxide to carbon dioxide by air in the presence of the diatomic hydrogen, but without oxidizing substantial quantities of the H₂ itself. The preferential oxidation reaction is as follows:

CO+O₂→CO₂ (4)

Prefox reactions may be either (1) adiabatic (i.e., where the temperature of the reformate (syngas) and the catalyst are allowed to rise during oxidation of the CO), or (2) isothermal (i.e., where the temperature of the reformate (syngas) and the catalyst are maintained substantially constant during oxidation of the CO). The adiabatic Prefox process is typically effected via a number of sequential stages which progressively reduce the CO content. Temperature control is important in both systems, because if the temperature rises too much, methanation, hydrogen oxidation, or a reverse shift reaction can occur. This reverse shift reaction produces more undesirable CO, while methanation and hydrogen oxidation negatively impact system efficiencies.

In either case, a controlled amount of O₂ (e.g., as air) is mixed with the reformate exiting the shift reactor, and the mixture is passed through a suitable catalyst bed known to those skilled in the art. For the Prefox process to be most efficient in a dynamic system (i.e., where the flow rate and CO content of the hydrogen-rich reformate vary continuously in response to variations in the power demands on the fuel cell system), the amount of O₂ (e.g., as air) supplied to the Prefox reactor must also vary on a real time basis in order to continuously maintain the desired oxygen-to-carbon monoxide concentration ratio for reaction (5) above.

The selective oxidation reaction has been found to suffer from an increased concentration of the undesired carbon monoxide during continued operation. While the prior art has suggested that there may be a blanket of carbon monoxide that is preventing the oxygen access to reactive sites and that exposing the catalyst to a low partial pressure of carbon monoxide will remove this layer. In accordance with this hypothesis, the prior art apparatus has restored the catalyst function through use of periodic reversals of the process flow across the catalyst bed in order to cause the CO in the CO-rich regions of the catalyst to be desorbed from the catalyst.

In accordance with the present invention, a much simpler and easier to implement procedure has been found to restore the selective oxidation catalyst performance. It has been found that removal of the oxygen from the feed to the selective combustion catalyst results in restoration of the catalyst performance as shown in the examples. Contrary to the teachings of U.S. Pat. No. 5,750,076 B1 and U.S. Pat. No. 5,518,705 B1, it has been found unnecessary to strip the carbon monoxide from the catalyst by reversal in flow of the fuel stream. One possible explanation for the successful restoration of the catalyst performance in the present invention is that the active catalyst sites become overly saturated with oxygen and a period of oxygen deprivation results in alleviation of this situation.

There are several variations on the present invention that have been found to provide desirable results. In one embodiment of the invention there is provided a single reaction chamber containing catalyst for promoting oxidation of carbon monoxide to carbon dioxide. A fuel inlet provides a hydrogen-rich fuel containing about 1000 to about 20,000 ppm-volume of carbon monoxide into the reaction chamber. An oxygen inlet provides an oxygen-rich stream, such as air, to the reaction chamber. There is also provided a means for periodically interrupting the flow of the oxygen-containing stream. Additional optional components of the apparatus of the invention include any of the following items. There may be a heat exchange zone located either adjacent to or after the reaction chamber. A single or multiple temperature sensing elements can be installed within the reaction chamber. There may be a means of measuring the flow of the oxygen-containing stream. A timer may be incorporated into the apparatus to provide a signal causing the oxygen flow to be interrupted for a predetermined period of time. Instead of separate inlets for the hydrogen fuel and the oxygen-containing streams, there may be a single inlet that combines both streams. At least one carbon monoxide sensing element may be located near the reaction chamber outlet or other desired location within the reaction chamber.

The frequency and duration of the oxygen stream interruptions may be controlled by several methods, not limited to those explained herein. One method of controlling the frequency and duration of the oxygen stream interruptions is to interrupt the oxygen flow at a timed interval for a set duration of time. Depending upon the operation of the unit, it may be found that the interruption should be for several seconds out of every few minutes. However, under other operating conditions, the interruption may be for a period of time measurable in seconds but only occurring every 10 to 80 hours of operation or even more. In experiments, it has been found to be particularly effective to interrupt the flow every 6 to 8 hours for 15 to 30 seconds for each interruption while the interruption may not be necessary for as much as every 50 hours of operation.

An important provision in the operation of the present invention is that the carbon monoxide level in the effluent product stream remain under the maximum allowable level. If the flow of oxygen were to be stopped indefinitely, then the carbon monoxide level within the reaction chamber would eventually rise to the level of the carbon monoxide concentration at the inlet to the reaction chamber. Unexpectedly, it has been found that interruptions in the flow of oxygen of about 5 seconds allow the CO concentration to be controlled below 4 ppm-vol. Measurements of the build up of carbon monoxide concentration under particular operating conditions will allow one skilled in the art to program the duration and frequency of the oxygen interruption process of the present invention.

A second method of controlling the oxygen stream interruptions is based upon the catalyst bed temperature profile change that occurs during the selective oxidation catalyst deactivation. As the catalyst deactivates, less reaction occurs near the inlet and the temperature profile of the bed changes. The temperatures near the front end of the bed decrease as less exothermic reaction is completed. The temperatures at the outlet of the bed either remain constant in the case of an adiabatic reactor with complete conversion of oxygen and without heat exchange, or may increase if a heat exchange zone is installed adjacent to the reaction chamber to remove the heat of reaction directly from the catalyst bed. The heat released from the oxidation reaction is transferred out of the catalyst bed through the chamber walls. As the catalyst deactivates, less reaction occurs closer to the catalyst bed inlet and the temperature at the 50% bed position drops. At the same time, the temperature near the outlet of the bed increases as the exothermic reaction is shifted towards the outlet of the bed. For example, in one set of process conditions, the oxygen interruption would be triggered when the temperature difference between the 50% bed position (as measured from the inlet to the outlet) and the 90% bed position drops below a predetermined value. When the oxygen is interrupted, the temperatures at all bed positions fall rapidly due to the interruption in the reaction. A drop in temperature below a predetermined value may be used as the trigger to restart the flow of oxygen. Alternatively, the restart of the flow of oxygen could be at a predetermined time period after the start of the interruption.

In another embodiment of the invention, there is added a second reaction chamber. Control of the oxygen interruptions to each reaction chamber can be accomplished by methods similar to those employed with a single reaction chamber. It has been found that having a second reaction chamber provides the advantage of decreasing the amount of oxygen required for each reaction chamber while maintaining a sufficient amount of total oxygen flow to complete the reaction. Interruption of the oxygen flow to the first and the second reaction chambers could occur at the same time or preferably at different times. It has been found that by interrupting the oxygen flow at different times it is possible to extend the interruption time and allow greater rejuvenation of catalyst function.

In a third embodiment of the invention, which is a variation on the second embodiment, the flow of the oxygen-containing stream is never stopped to the apparatus as a whole. Instead, the flow is redirected from the first reaction chamber to the second chamber or from the second to the first chamber. There is provided a single line to the reaction chambers with a three way valve to connect the oxygen stream to the first and second reaction chambers. The purpose of the three way valve is to direct the oxygen-containing stream to either the first or second reaction chamber or to both at the same time.

### DETAILED DESCRIPTION OF THE DRAWINGS OF THE APPARATUS

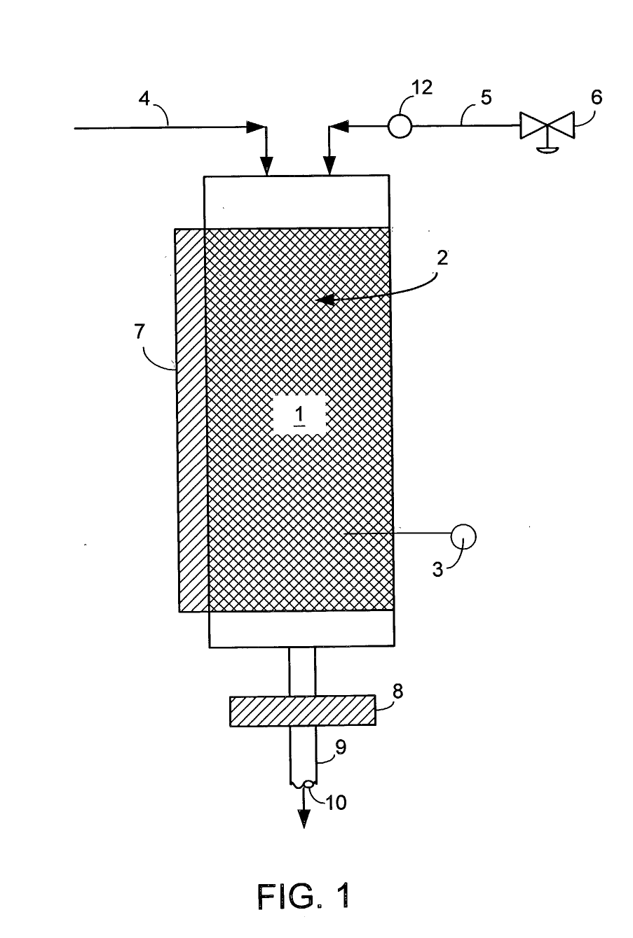

The invention will be further described with reference to FIG. 1. A reaction chamber 1 is shown with a catalyst 2 for selectively promoting the oxidation of carbon monoxide. Optionally, there may be included temperature sensing elements 3 within the reaction chamber 1. At least one fuel inlet 4 is provided for providing a hydrogen-rich stream of fuel into the reaction chamber 1. This hydrogen-rich stream of fuel is supplied to the fuel inlet 4 through a supply line that passes from an integrated reforming and water gas shift conversion zone (not shown). At least one air inlet 5 provides a flow of oxygen to the reaction chamber 1. The fuel stream and the oxygen stream may be supplied to the reaction chamber 1 through a single supply line or through separate lines (as shown). Located on the air inlet 5 is a means to control the oxygen flow 6, such as a valve, to interrupt and resume the flow of oxygen through the air inlet 5. A flow sensing element 12 is optionally present to measure the volume of air flowing through the inlet. A heat exchange zone 7 is optionally located adjacent to the reaction chamber 1 and a second heat exchange zone 8 may be located next to an outlet 10 of the reaction chamber 1. An optional carbon monoxide sensing element 9 will measure CO content of the hydrogen-rich stream as shown. When present, the carbon monoxide sensing element 9 can send a signal to the means to control the oxygen flow that results in an interruption in the flow of oxygen upon sensing an increase in carbon monoxide concentration above a predetermined level. The hydrogen-rich stream of fuel that passes out of the outlet 10 may flow to another reaction chamber 1 for further treatment or may now flow to a fuel cell.

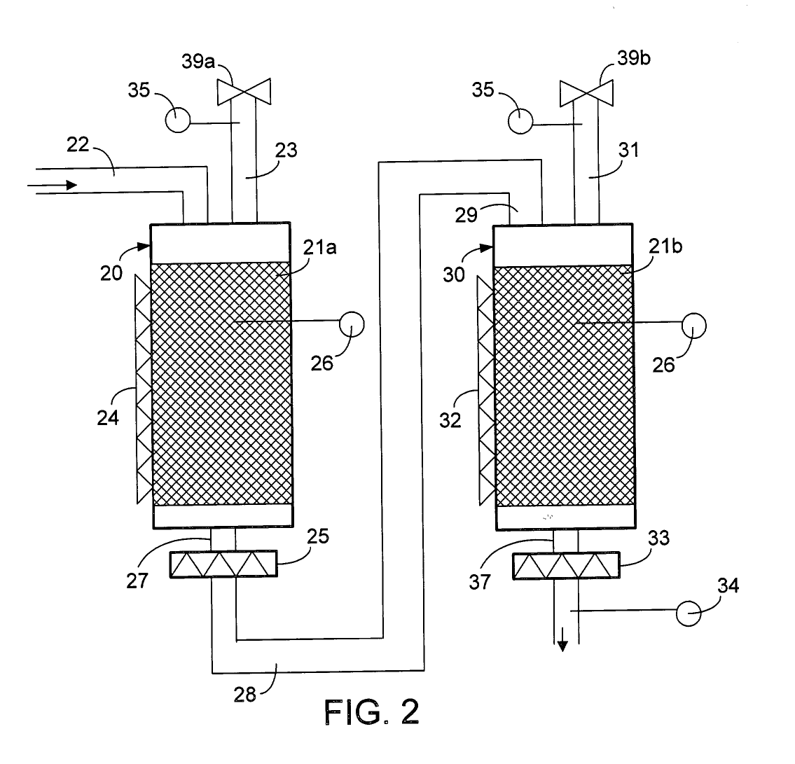

FIG. 2 displays a second embodiment of the invention having two reaction chambers in series. A primary reaction chamber 20 is shown having at least one bed of catalyst 21a for selectively promoting the oxidation of carbon monoxide. A fuel stream inlet 22 is shown connected to the primary reaction chamber 20 through which flows a hydrogen-rich fuel stream. An air inlet 23 provides a flow of oxygen to the primary reaction chamber 20 with the flow of air controlled by a valve 39a or other means for interruption of a gas flow. Also shown are heat exchange zones 24 and 25 that may be included in the apparatus and at least one temperature sensor 26. Gases from the primary reaction chamber 20 exit through an outlet 27 to a line 28 and then to an inlet 29 to a secondary reaction chamber 30 having at least one bed of catalyst 21b. An oxygen-containing stream enters the secondary reaction chamber 30 through an air inlet 31. Optional air flow sensors 35 are shown for measuring the flow of air on the air inlets 23, 31. The flow of the stream through the air inlet 31 can be interrupted by a valve, a compressor stop or other means for interruption of the flow of a gas as may be contemplated by one skilled in the art. In FIG. 2 is shown a valve 39b for this purpose. The secondary reaction chamber 30 may have heat exchange zones 32, 33 as shown in FIG. 2. The hydrogen-rich fuel stream leaves the secondary reaction chamber 30 through an outlet 37. A carbon monoxide sensor 34 may be present to measure the carbon monoxide content of the hydrogen-rich fuel stream.

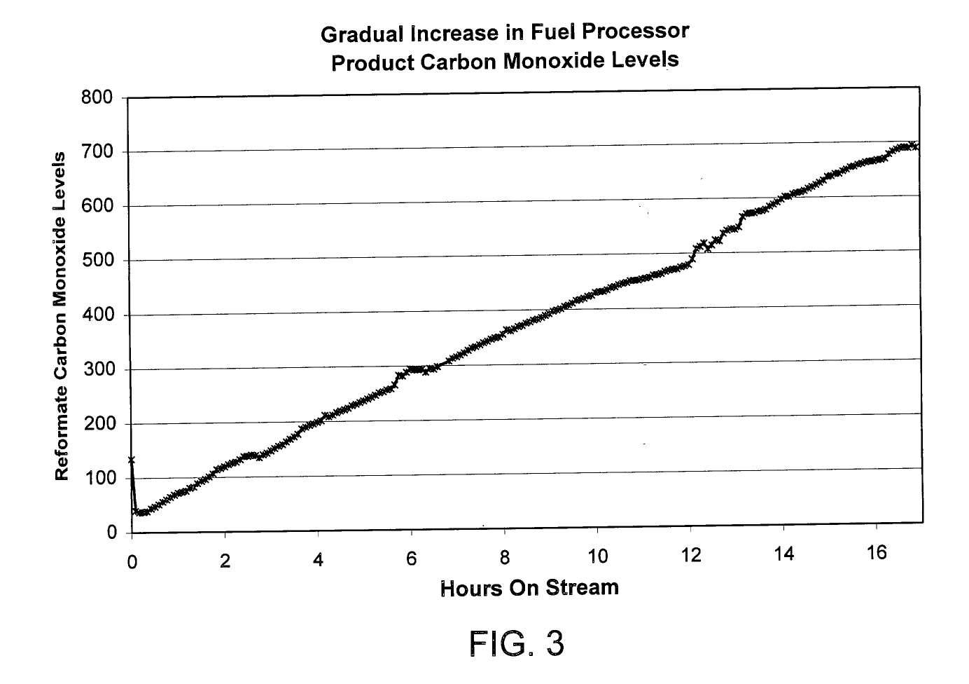

FIG. 3 shows the gradual increase in fuel processor product carbon monoxide that results from not using the oxygen flow interruption of the present invention. On the X-axis is shown the hours that the stream of oxygen has continued without interruption and on the Y-axis is shown the reformate carbon monoxide level in part per million volume.

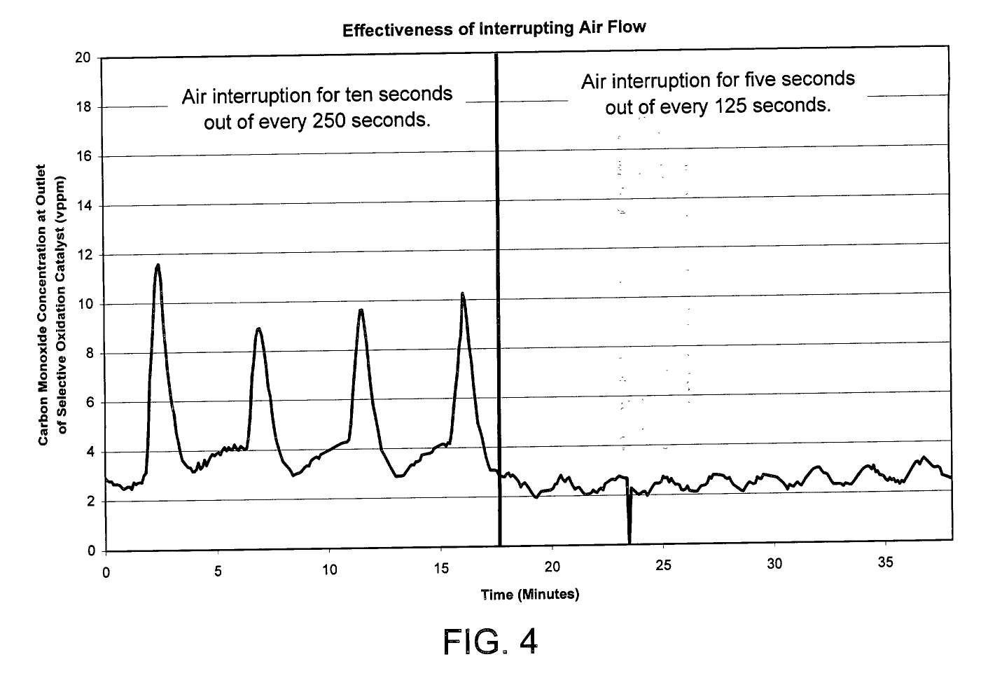

FIG. 4 is a chart illustrating the effectiveness of the flow interruption method of the present invention. On the left side of the vertical line is shown the carbon monoxide level ppm-vol. at the outlet to the reaction chamber when the air flow to the reaction chamber was interrupted for ten seconds out of each 250 seconds and on the right side is shown the carbon monoxide level when the air flow was interrupted for five seconds out of every 125 seconds. This latter time period is shown to be greatly preferable since the level of CO was maintained under 4 ppm-vol. while with the longer periods of interruption, the level would peak in the 9 to 12 ppm-vol range.

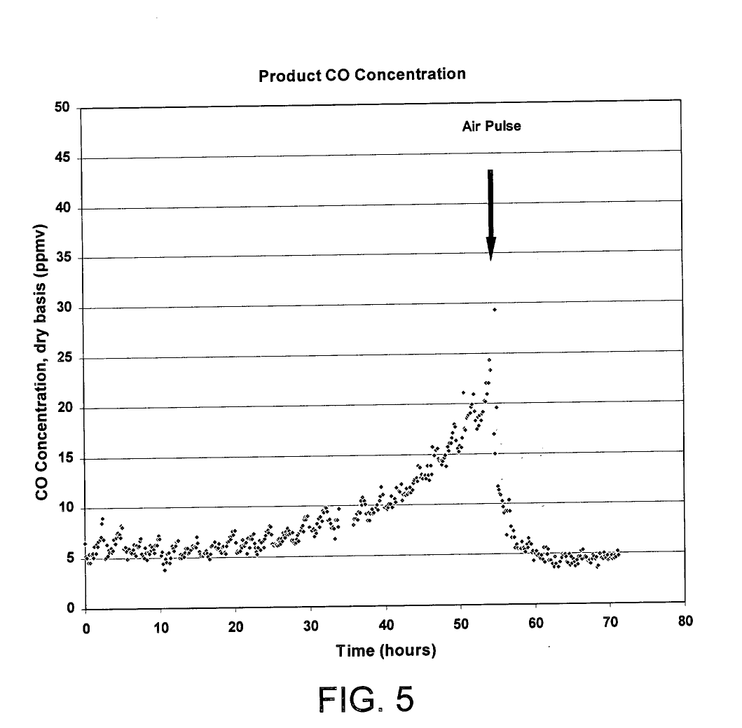

FIG. 5 is a chart illustrating the effectiveness of an air pulse of ten seconds duration that is administered after about 52 hours of operation. The Y-axis is the CO concentration, dry basis and the X-axis is time in hours.

### EXAMPLE 1

A fuel processor consisting of a partial oxidation reactor, a preferential oxidation reactor and a burner zone as disclosed in U.S. Pat. No. 6,190,623 B1 was operated on a natural gas feedstock at a feed rate equivalent to about 100 percent of the design throughput to provide a hydrogen fuel stream for use in a fuel cell to generate electric power. In general, it is desired that the concentration of carbon monoxide in the hydrogen fuel gas be maintained at 5 ppm-vol in order to avoid damage to the fuel cell. In a control experiment, the operation of the reactor was maintained with an uninterrupted flow of oxygen. FIG. 3 shows the gradual increase in fuel processor product carbon monoxide level over a period of over 16 hours. The CO level is shown to steadily increase.

### EXAMPLE 2

The apparatus described in Example 1 and employing the single reaction chamber apparatus of FIG. 1 was operated with the flow of oxygen interrupted for a timed interval for a set duration of time. The carbon monoxide level at the inlet to the reaction chamber was measured at approximately 3000 ppm-vol. In FIG. 4 are shown two conditions, in the first experiment, the flow of oxygen-containing gas was interrupted for ten seconds out of every 250 seconds. In the second experiment, the flow was interrupted for five seconds out of every 125 seconds. Based upon the results of the experiment it was found that employing more frequent, short interruptions of the air flow maintained the carbon monoxide level at a desirable low level of 4 ppm-vol. The maximum carbon monoxide level was much higher when the less frequent, longer interruption of air set of conditions.

What is claimed is:

1. A process of selectively oxidizing carbon monoxide in a reformate stream comprising the steps of:
a) passing a fuel stream comprising hydrogen and carbon monoxide into a reaction chamber wherein said reaction chamber contains an effective amount of at least one catalyst to selectively promote oxidation of said carbon monoxide to carbon dioxide in the presence of hydrogen;
b) supplying an oxygen-containing stream into said reaction chamber; and
c) periodically interrupting the flow of said oxygen-containing stream into said reaction chamber.

2. The process of claim 1 wherein a heat exchange zone is located next to said reaction chamber.

3. The process of claim 1 wherein said periodic interruption of the flow of said oxygen-containing stream is at preset intervals of time for desired periods of time.

4. The process of claim 1 wherein said fuel stream and said oxygen-rich stream are supplied to said reaction chamber through a single supply line.

5. The process of claim 1 wherein said fuel stream and said oxygen-rich stream are supplied to said reaction chamber through separate supply lines.

6. The process of claim 1 wherein said periodic interruption of the flow of oxygen is for a sufficient period of time to result in reduced levels of carbon monoxide flowing out of the chamber and reduced levels of buildup of carbon monoxide within said chamber.

7. The process of claim 1 wherein said periodic interruption in the flow of oxygen is controlled by a flow controller comprising a measuring means and an oxygen flow control means to said reaction chamber in response to a signal received from said measuring means.

8. The process of claim 7 wherein said measuring means is at least one element selected from the group consisting of a carbon monoxide level sensing element and a temperature sensing element.

9. The process of claim 8 wherein said temperature sensing element signals said oxygen flow control means stops said flow of oxygen upon sensing a reduction in temperature below a predetermined level.

10. The process of claim 8 wherein said carbon monoxide level sensing element signals said oxygen flow control means stops said flow of oxygen upon sensing an increase in carbon monoxide concentration above a predetermined level.

11. An apparatus for selectively oxidizing carbon monoxide to carbon dioxide in a fuel stream comprising hydrogen and carbon monoxide, said apparatus comprising:
a) a primary reaction chamber comprising a primary catalyst bed for promoting oxidation of carbon monoxide to carbon dioxide, said primary reaction chamber further comprising
i. at least one inlet for directing said fuel stream through said primary catalyst bed
ii. at least one inlet for directing an oxygen-containing stream through said primary catalyst stream;
b) a flow controller for periodically interrupting the oxygen-containing stream flowing into said primary reaction chamber; and
c) at least one outlet from said primary reaction chamber.

12. The apparatus of claim 11 wherein said flow controller comprises
a) a means to measure at least one property within said reaction chamber, a means to signal when said at least one property has reached a predetermined level and a physical means to interrupt said oxygen-containing stream in response to the receipt of said signal; and
b) a means to measure when said at least one property has reached a second predetermined level in response to said interruption of said oxygen-containing stream within said reaction chamber, a means to signal said physical means to resume the flow of said oxygen-containing stream.

13. The apparatus of claim 12 wherein said means to measure at least one property is at least one device selected from the group consisting of a carbon monoxide sensing element and a temperature measuring device.

14. The apparatus of claim 11 further comprising a timer, wherein said timer sends a signal to said oxygen flow control means to interrupt said oxygen-containing stream at predetermined intervals and for predetermined duration.

15. The apparatus of claim 11 wherein said flow controller comprises a valve.

16. The apparatus of claim 11 further comprising a second reaction chamber containing a catalyst for promoting oxidation of carbon monoxide to carbon dioxide, wherein said outlet from said primary reaction chamber connects to a line that connects to an inlet of said second reaction chamber, and wherein a fuel stream comprising hydrogen and carbon monoxide passes from said primary reaction chamber to said second reaction chamber and wherein said second reaction chamber further comprises an inlet for an oxygen-rich stream to pass into said second reaction chamber and further comprising an oxygen interrupting means.

17. The apparatus of claim 13 wherein said carbon monoxide level sensing element is located near the outlet of the reaction chamber to measure the carbon monoxide level in the hydrogen-containing stream.

18. The apparatus of claim 17 wherein said carbon monoxide level sensing element triggers the interruption of the oxygen-rich stream and said interruption continues until the carbon monoxide level drops below a predetermined level.

19. The apparatus of claim 11 wherein said catalyst comprises ruthenium metal dispersed on an alumina carrier.

20. A process for the generation of a hydrogen-rich fuel gas stream for use in a fuel cell for the generation of electric power, said process comprising:
a) passing a feed stream comprising a hydrocarbon or an oxygenate to a fuel processor comprising an integrated reforming and water gas shift conversion zone to produce a fuel stream comprising hydrogen, carbon monoxide, carbon dioxide and water;
b) passing the fuel stream at an oxidation temperature between 70° C. and less than 160° C. in the presence of an oxygen-containing stream to a preferential oxidation zone containing a preferential oxidation catalyst to produce the hydrogen-rich fuel gas stream comprising less than about 50 ppm-vol carbon monoxide, said preferential oxidation catalyst consisting of ruthenium metal dispersed on an alumina carrier having an apparent bulk density of about 0.2 to about 0.4 g/cc and wherein at least a portion of said alumina carrier has an average pore size of about 800 to about 1500 angstroms;
c) periodically, interrupting said oxygen-containing stream for a period of time sufficient to maintain said carbon monoxide below a desired level; and
d) passing the hydrogen-rich fuel gas stream to a fuel cell for the generation of electric power and withdrawing electric power.
